(19) United States
(12) Patent Application Publication
(10) Pub. No.: US 2001/0035976 A1
(43) Pub. Date: Nov. 1, 2001

(54) Method and system for online presentations of writings and line drawings

(76) Inventor: Andrew Poon, San Jose, CA (US)

Correspondence Address: R. Alan Burnett, Law Office of Alan Burnett, 13419 SE 42nd Street, Bellevue, WA, 98006-1306, US

(21) Appl. No.: 09/785,050

(22) Filed: Feb. 13, 2001

Related U.S. Application Data
(60) Provisional application No. 60/182,684, filed on Feb. 15, 2000.

(51) Int. Cl. G06K 15/00; G06K 9/40; G10L 19/00; G10L 21/00; G06K 9/56; G06T 5/20; G06T 5/50; G06T 5/00

(52) U.S. Cl. 358/1.15; 382/275; 704/500; 382/165; 382/308; 382/263; 358/403

(57) ABSTRACT

A method and system for enabling writings and/or drawings created during or in advance of a virtual meeting or the like to be electronically delivered to an online audience or stored for subsequent on-demand viewing such that the writings and/or drawings may be replicated on an audience member's computer in a manner that makes them clearly readable. The invention is implemented via a software application that runs on a computer to which a video capture device is connected. The software application and/or computer peripheral components process captured video content to filter out data that do not pertain to the writings and/or drawings, based on the unique characteristics of writings and drawings as compared with other artifacts that may occupy the visual images. The remaining pertinent data is then transmitted to the on-line audience or saved for later on-demand viewing. In an additional implementation, a composite image comprising a writing area portion and an additional portion of the visual content of the presentation is replicated for online viewing.

### RELATED APPLICATIONS

The present application is based on a provisional application entitled “VIDEO WHITEBOARD”, Ser. No. 60/182,684, filed on Feb. 14, 2000, the benefit of the filing date of which is claimed under 35 U.S.C. § 119e.

### BACKGROUND OF THE INVENTION

1. Field of the Invention

This invention relates generally to data communications, and more particularly, to a method and system for enabling writings and/or drawings created during or in advance of a virtual meeting or the like to be electronically delivered to an online audience or stored for subsequent on-demand viewing such that the writings and/or drawings may be replicated on an audience member's computer in a manner that makes them clearly readable.

2. Background Information

Advances in computer capabilities and the emergence of the Internet have created a network of powerful computers. This infrastructure enables one or more people to communicate via their respective computers using audio, video, chat, and other forms of sharing text and video images. With communication speeds between computers becoming ever faster and more economical, it is now possible for people to engage in communication activities that have not been possible before.

One of the largest areas of human activities enabled by this network of computers is that of virtual meetings. The types of activities in this area include electronic conferencing, online presentations, online chat, and distant learning, to name a few. The common characteristic of these activities is that whenever two or more people need to share information of a complex nature, they used to have to physically come together, in order to be able to talk, make gestures, use facial expressions and body language, show diagrams, make sketches, and so on, in order to communicate the complex information involved. Today's computers are equipped with audio and visual capabilities that can produce the effects of these actions. High-speed data exchange abilities further enable these actions to be produced in near real time. Thus, complex communication tasks can now be accomplished without requiring the parties to physically come together. This ability means geographic separation is no longer a barrier to communications. Two people can be continents apart and yet share thoughts and information in an instant's notice. The savings in time and labor by avoiding travel to meet another person are tremendous. This infrastructure of networked computers allows many forms of virtual meetings to take place where the barriers of space and time are virtually eliminated.

As powerful and useful this new infrastructure is, many inadequacies remain. In this paradigm of communicating through the use of connected computers, two major factors play critical roles. One is the ability of the computer to create sight and sound, which allows speech, gestures, and images to be captured on one computer and sent to another computer, which then reproduces the speech, gestures, and images to substantially the same form as the source. How true the recreated form is to the original determines how effective the speech, gestures, and images are in the communication activity. Clearly, speech and images that are well defined will have a greater impact than fuzzy or blurred ones.

The other major factor is communication speed, i.e., bandwidth. A high-speed connection between two computers allows more data to be exchanged per unit time. With high bandwidth, speech, gestures, and images can be provided with high fidelity and continuity, closely reproducing the live images of the original presentation, while slow bandwidth results in low fidelity and discontinuity, reducing the effectiveness, or tele-presence, of the communication.

In reality, the computer's ability to capture and reproduce visual content is barely workable for many virtual meeting applications. In addition, the bandwidth available for transmission of audio and video data is generally inadequate. As a result, the quality of the communication is generally of low quality, and oftentimes is simply unacceptable. Under conventional schemes, images are often blurred and frame updates are slow, resulting in jerky motions, thereby degrading the tele-presence, sometimes to such a level that the whole concept is rendered unusable.

In addition to virtual meetings, it is often advantageous to receive either live or prerecorded training or instruction, such as that taught in a classroom. In consideration of today's limited bandwidth and video capture technology, such online lessons are often limited to a set of pre-defined slides. Recently, the availability of an overlaid video image in combination with the pre-defined slides has been made available; however, the video image is very small (i.e., <200×200 pixels), and still results in many of the inadequacies discussed above. Ideally, it would be desirable to enable the instructor to use a chalkboard or whiteboard to present the lesson to an online audience in a manner in which the audience members could clearly see the writings and/or drawings as they are produced in real-time. However, due to the low resolution of the video images and the effects of uneven lighting and other environmental consideration, anything the teacher writes on the blackboard will be difficult if not impossible to decipher using the present techniques used in the prior art. This shortcoming severely limits the practicality of remote lessons.

### SUMMARY OF THE INVENTION

The present invention provides a method and system for enabling writings and/or drawings created during or in advance of a virtual meeting or the like to be electronically delivered to an online audience or stored for subsequent on-demand viewing such that the writings and/or drawings may be replicated on an audience member's computer in a manner that makes them clearly readable. The invention is implemented via a software application that runs on a computer to which a video capture device is connected. The software application and/or computer peripheral components process captured video content to filter out data that do not pertain to the writings and/or drawings, based on the unique characteristics of writings and drawings as compared with other artifacts that may occupy the visual images. The remaining pertinent data is then transmitted to the on-line audience or saved for later on-demand viewing.

According to a first aspect of the invention, the method enables visual content corresponding to writings and/or line drawings presented during a presentation to be captured and processed such that the visual content may be replicated for viewing by persons not attending the presentation. The method comprises directing a video capture device at a writing surface such that the writing surface occupies a substantial portion of a field of view of the video capture device. Appropriate video capture devices include video cameras (e.g., camcorders, both analog and digital output), web cams, and the like. Visual content pertaining to writings and/or line drawings created on the writing surface during the presentation or prepared on the writing surface in advance of the presentation is captured with the video capture device, producing a plurality of frames of pixilated data. If a digital video camera is used, it can directly produce the pixilated data. If the video camera produces an analog output signal, a video adapter is used to convert the analog signal into the frames of pixilated data. The visual content is then “cleaned up” by processing the frames of pixilated data to remove data corresponding to artifacts in the visual content that do not pertain to the writings and/or line drawings through application of a set of image processing functions that remove such data based on unique characteristics of writings and/or line drawings that are used to distinguish pixilated data pertaining to the writings and/or line drawings from the pixilated data pertaining to the artifacts.

There are several image processing functions that may be implemented by the invention to clean up the visual content. These functions are selected based on the unique characteristics of writings and line drawings. These characteristics include visual images of writings and line drawings contain mostly empty space; there is a high contrast between the writings and the background; the content comprises mostly lines on a continuous color background; the writings and drawings do not move; and the writing surface is stationary.

The processing functions may include a flat field correction, a blob analysis, image averaging, thresholding, and subtraction. They also may include a morphological analysis and color classification. For some functions, it is preferable to perform a color to grayscale conversion before applying the functions. It is noted that there is considerable flexibility in applying these processing functions. Depending on the particular characteristics of the video image, the clean-up functions can be rearranged or substituted with similar but somewhat different image processing and analysis techniques. The key point is not the exact set or sequence of such image processing functions used, but rather the process of applying image processing and analysis techniques to a video image with the purpose of exploiting the characteristics of writings as discussed herein in order to gain advantages over the prior art. It should be appreciated that one skilled in the art can add, subtract, or substitute one or more of the functions, apply different parameters to any function, or modify the order of the functions, to accomplish similar results.

After the image data has been cleaned up, it is compressed and either transmitted over a network, such as the Internet, to online audience members' computers, or stored in a file for later on-demand viewing. Upon being received at the online audience members' computers, the compressed image data is decoded (e.g., decompressed and scaled) to produce a replication of the visual content of the original presentation.

According to other aspects of the method, audio data can also be captured and replicated, whereby the replication of the audio content is produced such that it is synchronized with the replication of the video content. In such implementations, the audio content is captured by a microphone, which may be built into the video capture device, such as the case with camcorders. The audio content is digitized (either by the video capture device or through use of an audio adapter coupled to the computer running the application software), and compressed, and is then sent over the network to the online audience members' computers. Typically, the audio and visual content will be transmitted over the Internet using a streaming format. The content may also be transferred over local networks (LANs) and wide-area networks (WANs).

According to alternative implementation of the method, a composite image comprising a first portion corresponding to writings and/or line drawings presented during a presentation and a second portion corresponding to additional visual content corresponding to the presentation is replicated on an online audience member's computer. This is accomplished by enabling the presenter or other user to define a portion of the field of view of the video capture device corresponding to a writings area in which the writings and/or line drawings will be displayed during the presentation, and another portion corresponding to an additional area of the visual content that is to be replicated, such as an area occupied by the presenter. As the visual content is captured, the portions of pixilated data corresponding to the two areas are separated, whereupon the foregoing image processing functions are applied to the pixilated data corresponding to the writings area to produce a first portion of encoded data, and conventional image processing techniques, such as MPEG compression, are applied to the pixilated data corresponding to the additional area to produce a second portion of encoded data. The two portions of encoded data are then transmitted over a communications network to the on-line audience members computers, whereupon they are decoded to produce a composite image that comprises a replication of both the writings area portion and the additional area portion of the visual content of the presentation.

According to further aspects of the invention, the system comprises a computer including memory and a processor. The computer executes machine instructions comprising the software application that are stored in the memory. Preferably, the machine instructions are read into the memory from an article of manufacture, such as a CD ROM, on which the machine instructions are stored. The system may further include a second computer comprising one of the online audience member's computers connected to the first computer via a network, such as the Internet. The second computer also includes memory and a processor, and executes machine instructions comprising a software application or module that are used to decodes incoming data and perform further processing to replicate the visual content of the presentation on the computers display screen.

An important aspect of the present invention worth noting is that, due to the high compression afforded by the filtering functions in the process, the amount of data required to represent writings and drawings is substantially reduced from the original video images. This reduction in data size enables efficient archiving of the writings, as well as reduced transmission bandwidth requirements.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of a general-purpose computer system with attached peripherals and connections suitable for implementing the present invention;

FIG. 2 is a schematic block diagram illustrating the primary hardware and software components utilized by one embodiment of the present invention to connect, monitor and administer a virtual meeting with ability to capture and transmit hand written and hand drawn information during the virtual meeting;

FIG. 3 is functional flowchart illustrating a plurality of optional image processing functions that may be performed on original image data to produce cleaned and compressed image data that significantly reduces the bandwidth required to facilitate a virtual meeting;

FIGS. 4A and 4B illustrate an exemplary set of pixilated data before and after a morphological filtering function has been applied.

FIGS. 5A and 5B illustrate the effectiveness of the present invention by showing an actual image produced by a capturing device and the resultant image after going through the image processing functions provided by the present invention;

FIGS. 6A, 6B, and 6C respectively show an original image, the original image after it has been compressed using a prior art scheme, and the original image after it has been cleaned and compressed using techniques taught by the present invention, wherein the number of bytes corresponding to each image is provided adjacent to that image;

FIG. 7 is a representation of a user interface dialog that enables a user to adjust various parameters to control the replication of the visual images;

FIG. 8 is a representation of a user interface dialog that further enables a user to select a writing area and an additional area to be processed using different image processing schemes to produce a composite replicated image; and

FIG. 9 is a flowchart illustrating the logic used by the invention when operating in a composite image mode.

### DETAILED DESCRIPTION OF THE ILLUSTRATED EMBODIMENTS

The present invention provides a method and system for efficiently communicating information of a handwriting or hand sketch nature that may be used during virtual meetings, online instructions, and the like. The following description is presented to enable one of ordinary skill in the art to make and use the invention and is provided in the context of exemplary preferred embodiments. Various modifications to the preferred embodiments will be readily apparent to those skilled in the art and the generic principles defined herein may be applied to other embodiments. Thus, the present invention is not intended to be limited to the embodiments shown herein, but is to be accorded a scope consistent with the principles and features described herein.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Exemplary Computer System and Network for Implementing the Invention

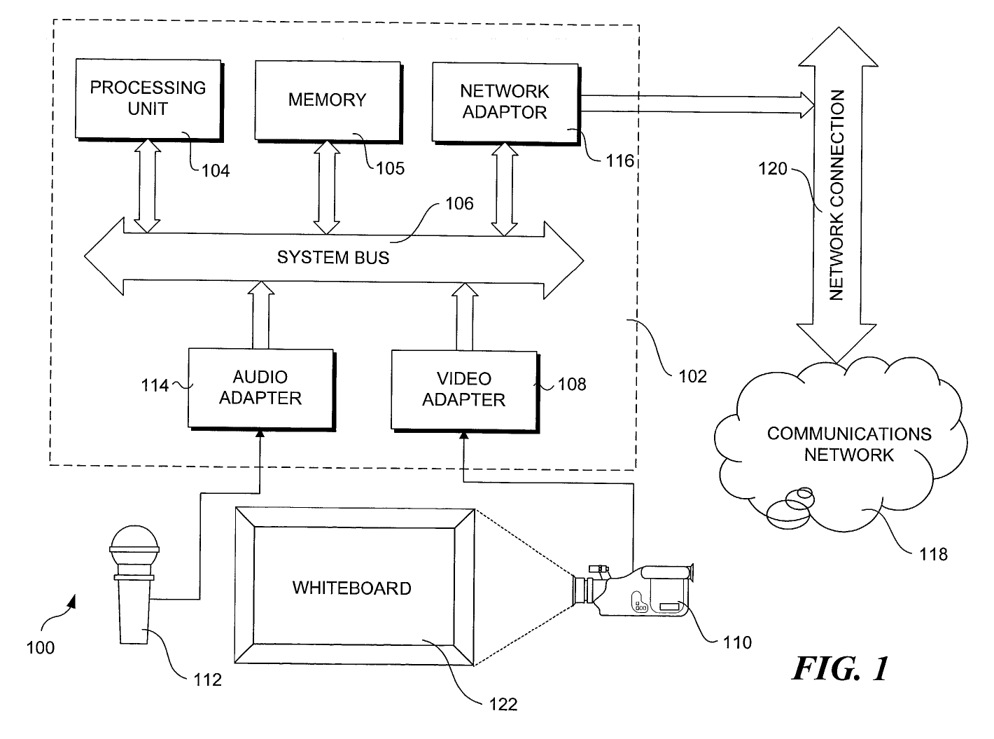

In accord with the present invention, a typical virtual meeting is initiated when a person (the presenter) desiring to communicate with one or more persons operating computers at locations remote from the presenter (the meeting attendees) starts a computer program equipped to host virtual meetings. This computer program typically resides on a personal computer, which has installed on it a microphone and web cam used to capture the sights and sounds of the presenter and/or other participants in the presentation. This computer also has a connection to a network, to which the other persons in the virtual meeting party are also connected. Thus, the sights and sounds of the presenter are captured by the presenter's computer and sent to the other meeting participants via the network connection. FIG. 1 shows a typical computer set up for use in such a virtual meeting, which is a suitable computing environment in which the invention may be implemented.

Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, specialized hardware devices, network processes, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system 100 for implementing the invention includes a general purpose computing device in the form of a conventional personal computer 102 comprising a processing unit 104 for processing program and/or module instructions, a memory 105 in which the program and/or module instructions may be stored, a system bus 106, and other system components, such as storage devices, which are not shown but will be known to those skilled in the art. The system bus serves to connect various components to processing unit 104, so that the processing unit can act on the data coming from such components, and send data to such components. For instance, system 100 may include an internal or external video adapter 108 that is used to process video signals produced by a web cam 110. The video adapter has the ability to receive video images captured by web cam 110 in the web cam's data format, and if necessary, convert and present this data to the processing unit 104, through system bus 106. Similarly, audio input, such as speech, is input through a microphone 112 and received by an audio adapter 114, which converts that audio data from microphone 112's native format to a digital format (as necessary) that may then be delivered to processing unit 104 via system bus 106 for further processing. In the context of the following discussion, the video adapter 108 and audio adapter 114 are described as standalone components. It will be understood that the functionality provided by these components may be facilitated by both a stand-alone hardware device, or the hardware device combined with software drivers running on personal computer 102. In addition, a single peripheral card or device and associated software drivers may be used to provide the functionality of both video adapter 108 and audio adapter 114.

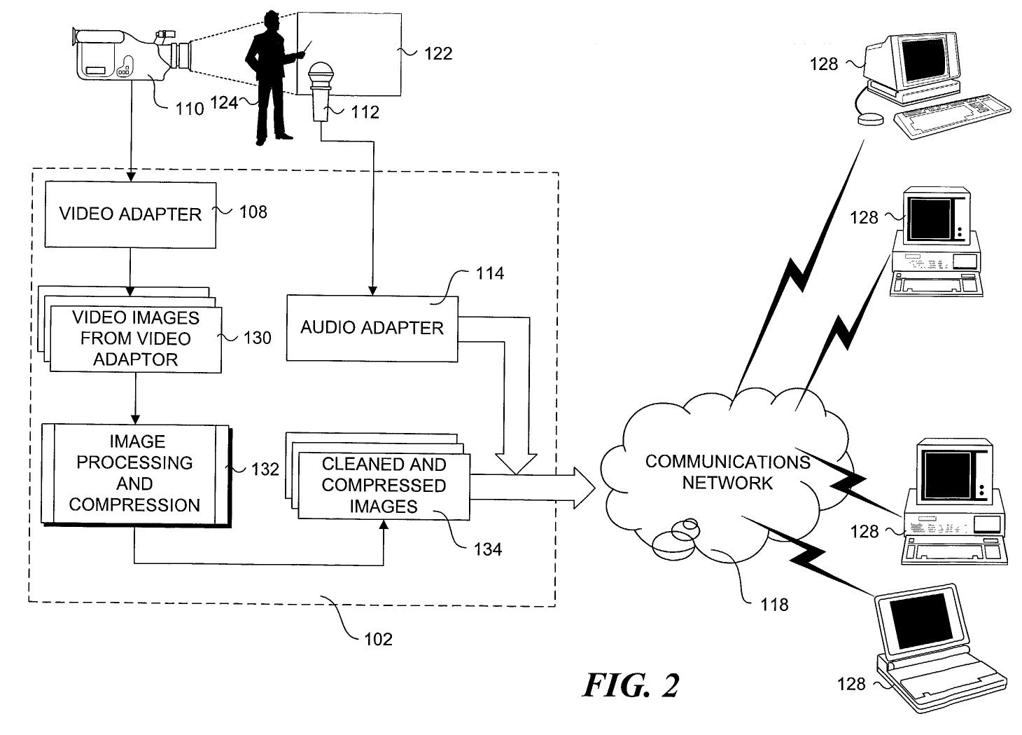

System 100 further includes a network adapter 116, such as a modem or Network Interface Connection (NIC) card to connect to a local area network (LAN) such as Ethernet or token ring network, thereby enabling communication between processing unit 104 and a network 118 via a network connection 120. As shown in FIG. 2, data sent to network 118 is received by a plurality of online audience members' computers 128, whereupon the data is decoded (e.g., decompressed and scaled) to produce cleaned-up images corresponding to original images provided by web cam 110 to computer 102 during a virtual meeting or classroom lesson, as described in further detail below.

In one implementation of the present invention, a writing surface, such as a typical office whiteboard 122, can be used for writing and sketching. Accordingly, web cam 110 is directed at whiteboard 122 so as to capture writings produced by a presenter 124 (see FIG. 2), while microphone 112 is used to capture speech and other audio signals produced by presenter 124 and possibly others attending the presentation in person.

System Architecture

As illustrated in FIG. 2, a virtual meeting involves a presenter's computer 102 communicating via communication network 118 with one or more online audience members' computers 128. The online audience members' computers 128 may be a personal computer, or equivalent devices such as workstations, laptop computers, notebook computers, palmtop computers, personal digital assistants (PDA's), cellular telephones and alphanumeric pagers. Communications network 118 may be a local area network (LAN), a dial-up network, an Internet connection, or any other type of communications network, including wireless communication networks.

During a virtual meeting, video signals produced by web cam 110 are sent to video adapter 108, where they are processed into a plurality of digital video images 130 on a frame-by-frame basis. Optionally, a digital video camera may be used for web cam 110 to directly produce digital video images 130. Digital video images 130 are then processed and compressed in a block 132 to produce cleaned and compressed image data 134. Cleaned and compressed image data 134 are then sent over communications network 118 to online audience members' computers 128, preferably using a standard streaming format. At the same time, speech and sounds made by presenter 124 are captured by microphone 112 and sent to an audio adaptor 114 in presenter's computer 102, which again converts the data, if necessary, to digital form, whereupon the digital data, which may optionally be compressed, is sent to the network 118 in substantial synchrony with cleaned and compressed image data 124 so that both sets of data arrive at meeting attendees computers 128 with a timing corresponding to the live presentation, thereby enabling both the visual and speech aspects of the presentation to be accurately recreated on the online audience members' computers.

As discussed above, it is desired to be able to enable the online audience members to clearly see what is written and/or drawn on whiteboard 122 during the virtual meeting. The inventor observes that live writings and drawings, such as those commonly made in the course of a classroom-style lesson or presentation, consist of a number of special characteristics that are leveraged during image processing functions provided by the present invention to provide significant advantages over the prior art. These characteristics include:

1. The visual image contains mostly empty space

As a presenter writes or sketches on a writing surface such as a whiteboard, the writing surface remains mostly empty, relative to the amount of “paint” (i.e., lines comprising the writings and/or illustrations) thereon. This characteristic is considered during image processing in accord with the present invention to substantially eliminate this empty place from the image data before it is transmitted to the audience, thereby eliminating a substantial portion of data that would have been normally transmitted in accord with techniques found in the prior art.

2. High contrast between the writings and the background

The writing surface such as a whiteboard and the writing apparatus such as a pen are designed to produce a high contrast for easy reading. Accordingly, image processing techniques such as thresholding can be used to eliminate undesirable graphical artifacts, such as light reflections, which are distinguishable from the writings since such reflections are of lower contrast.

3. Mostly lines

The apparatus used to create writings and sketches is usually a pen, which makes narrow lines, as opposed to grayscale patterns such as photographs. Typically, video compression algorithms are designed to compress image data corresponding to real-world objects (e.g., people, landscapes, etc.), which correspond to images similar to photographs. As a result, using these video compression algorithms to compress images containing writings and line drawings has been shown to be very inefficient. In accord with the invention, line tracing and edge detection algorithms are applied during image processing to accurately extract the useful graphics from the background.

4. Immovable contents

Once writing is placed on the writing surface, the writing does not change. This characteristic enables the present invention to apply image processing techniques such as blob analysis to eliminate irrelevant graphics such as the instructor's hand and the writing apparatus from the images, leaving only the writings.

5. Stationary surface

Typically, writing surfaces, such as a whiteboard or chalkboard, are generally placed into position and then remain in place as writings are made on them. The present invention leverages this characteristic by aligning two successive video frames with reference to the stationary whiteboard and extracting only the graphics that has either been added or removed between the frames, thereby obtaining a further reduction in the amount of data required to be transmitted to the audience to obtain viable replication of the original writings and drawings.

In one embodiment, the present invention may be implemented as a computer program running on a personal computer. The program controls a video capturing device, such as web cam 110. The images captured by the web cam are fed into the program at a certain rate measured in frames per second. Each frame, in digital form, is a collection of numbers comprising pixilated data that represents the pattern of colors that forms the camera's view. This collection of numbers may be obtained directly from some video capturing devices, or may be obtained from a video adapter that receives signals from the web cam and/or driver software for the video adapter and placed into portions of the computer's memory as a data buffer. Each data buffer is then passed through a number of optional processing functions. These functions “clean” the original video image based on the unique characteristics of writings and drawings described above. It must be emphasized that there is considerable flexibility in applying these processing functions. Depending on the particular characteristics of the video image, the clean-up functions can be rearranged or substituted with similar but somewhat different image processing and analysis techniques. The key point is not the exact set or sequence of such image processing functions used, but rather the process of applying image processing and analysis techniques to a video image with the purpose of exploiting the characteristics of writings as discussed herein in order to gain advantages over the prior art. It should be appreciated that one skilled in the art can add, subtract, or substitute one or more of the functions, apply different parameters to any function, or modify the order of the functions, to accomplish similar results.

In the following exemplary embodiment, the present invention is implemented as a computer program running on presenter's computer 102. It will be understood, the present invention may be implemented in one or more software modules that are accessible to one or more application programs, as well as in the stand-alone application program described below.

Prior to the start of the virtual meeting, presenter 124 or another person present at the live meeting will direct web cam 110 toward whiteboard 122 and launch the application program. If desired, presenter 124 may select various options and configuration information corresponding to particular characteristics the presenter wishes to preserve in the replicated images produced on online audience members' computers 128 through a user interface provided by the application program. In general, the user interface will comprise a plurality of dialogs and/or pulldown menu options that enable various configuration information to be selected using a pointing device and/or keyboard input. The user interface concepts are well-known in the art, and accordingly, further details of the dialogs and menu options provided by the user interface are not discussed herein for brevity.

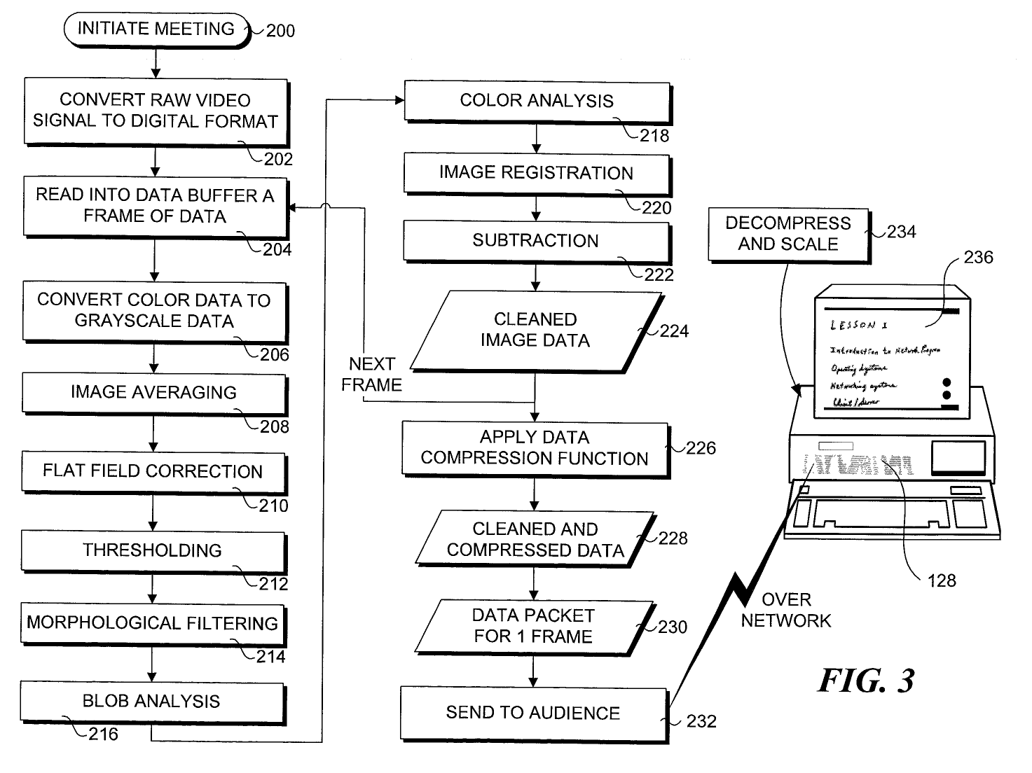

With reference to a block 200 in FIG. 3, the presenter initiates the virtual meeting by activating a user interface control in the application program (not shown) to start recording and/or broadcasting the virtual meeting, thereby enabling presenter's computer 102 to begin receiving video image data from web cam 110 at a rate measured in frames per second, which has been previously configured above. In a block 202, each frame is converted into digital form by video adaptor 108, resulting in a block of pixilated data comprising a series of numbers for each frame. Pixilated data comprises one or more data values for each pixel in the frame, wherein the total number of pixels will correspond to the resolution of the web cam. For instance, if the web cam has a resolution of 640×480, there will be 640 lines of pixels, wherein each line will include 480 pixels. As used herein, the term “pixilated” data means that each data attribute is stored in a manner in which its corresponding pixel can be identified.

As discussed above, some video devices are capable of directly sending digitized video data to a receiving unit, such as computer 102; in these instances, the use of video adapter 108 will not be necessary. Each data block is then sequentially read into memory by the application program in a block 204, whereupon a set of selectable image processing and compression functions are performed to significantly reduce the amount of data necessary to replicate the original image on online audience members' computers 128.

As will be understood, each of the following processing functions may be optionally performed. Rather than act as disparate functions, the various selectable processing functions may be combined together to transform the incoming image data in ways that emphasize or de-emphasize certain features in the images. Typically, web cam 110 will produce color images, and video adapter 108 will produce data blocks comprising RGB (red, green, blue) data attributes for each pixel. As many of the functions described below can operate more efficiently and reliably by processing grayscale data rather than color data, in one embodiment a first function comprises converting the incoming color RGB data to grayscale intensity data, as provided by a block 206. For example, many cameras and video adaptors produce color image data corresponding to a 24-bit RGB format, wherein each pixel is represented by 8-bits each of red, green and blue values. In a current implementation, each pixel is transformed to an 8-bit grayscale value representing the intensity of that pixel using the well-known conversion equations for RGB to YUV color space conversion, wherein the intensity is represented by the Y channel. The RGB to YCbCr color space conversion may also be used. It is noted that, depending on the selected image processing functions, the color data may be required for some of the subsequent processing functions, and therefore is not discarded at this point.

Next, in a block 208, running averages for the incoming images are computed. Many cameras, especially low cost ones, produce images with poor signal-to-noise ratios; this typically results in images which tend to look grainy and have constant color fluctuations. These artifacts greatly increase the amount of data required to represent the images and yet contain no useful information. It is well known that signal-to-noise ratios can be improved by taking many images of the same scene and then computing the average value for each pixel. However, in general, frame averaging cannot be used on live video effectively because many parts of the image are changing. For example, if the web cam was focused on the presenter, as is the typical case in the prior art, the movements of the presenter's hands and other body parts would be captured. This corresponds to a rapidly changing visual image that is not suitable for frame averaging. In contrast, most of the writings and/or lines drawn on a whiteboard or chalkboard remain constant between frames. Since most cameras produce frame rates at 10 to 30 frames per second, frame averaging can be applied to visual images of a writing surface to improve signal-to-noise ratio without any significant loss of image content. In a current implementation, the running average is set to 4 frames. This means that for each new frame N coming from the camera, pixel values from frame N−4 are subtracted from the total, and pixel values from frame N are added to the total on a pixel-by-pixel basis. The average is then computed by dividing each total value by 4.

In a block 210 a flat field correction of the grayscale image with a two dimensional high-pass filter is applied. As a result of this function, gradual spatial color changes are removed from the image. This eliminates shadows, reflections, lighting variations, etc., from the image. In one current implementation, the kernel width and height of the high-pass filter is set to half the width and height of the image respectively. The high-pass filter is realized by applying a two-dimensional convolution in the time domain, with all the kernel coefficients set to one and the divider set to the number of elements in the kernel, and then subtracting the result of the convolution with the original image. For example, if the image size is 640 by 480 pixels, then the kernel size is 320 by 240, with all the coefficients set to one and the divider set to 76800.

If the writing surface is darker than the pen, as will be the case if a traditional classroom blackboard is being used, pixel values (i.e, the 8-bit grayscale intensity value for each pixel) from the camera will be higher for the pen than the surface, and the high-pass filter can be applied to the grayscale intensity image exactly as described. If the writing surface is brighter than the pen color, as will be the case when a whiteboard is used, then the grayscale image from the camera must be inverted (by subtracting from each pixel value the maximum possible pixel value) before the high-pass filter is applied. For example, if pixels are represented as 8-bit values, then each pixel value V is transformed to 255−V if the writing surface is white.

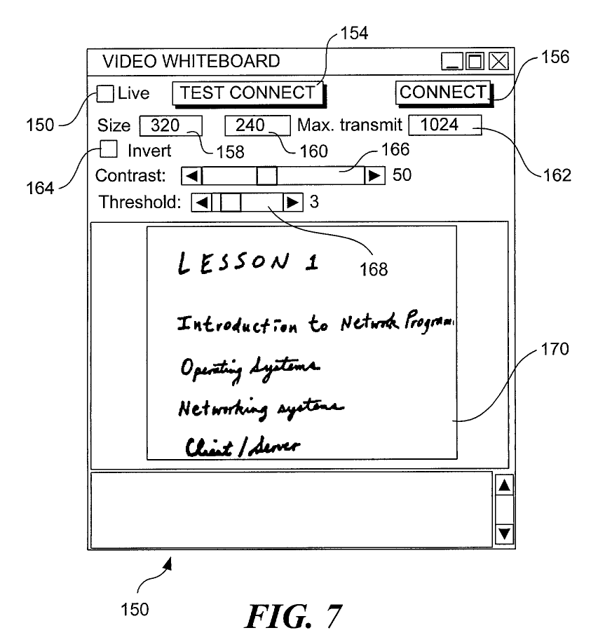

A thresholding function may be applied in a block 212. This is a process wherein pixels with low grayscale intensity values are filtered out. This function eliminates graphical noise such as nicks and marks on the writing surface, and electrical noise coming from web cam 110. In one current implementation, the threshold value is dynamically specified by means of a user interface element, as shown by a dialog 150 in FIG. 7. Dialog 150 includes a “Live” checkbox 152, a “TEST CONNECT” button 154, a “CONNECT” button 156, respective X by Y size fields (in pixels) 158 and 160, a maximum bytes per frame transmission field 162, and “Invert” checkbox 164, a contrast slide control 166, and a threshold slide control 168. Generally, the presenter or other operator of the equipment can adjust the threshold value using threshold slide control 168. In one embodiment, in response to the threhold adjustment (and other adjustments as well), the user is presented with a visual image 170 cooresponding to how the visual content of the presentation will appear when it is replicated. By selecting “Invert” checkbox 164, the data values of the pixels are inverted. This would typically be used for presentations conducted using blackboards—generally, it will be desired to have the replicated visual image comprise black or other color writings and lines over a white surface.

In addition to setting the threshold value using dialog 150, alternate ways of determining the threshold value may be implemented by those skilled in the art, such as: deriving it from a priori knowedge of the characteristics of the lighting or equipment used in capturing the images; computing the threshold value by examining the average darkness of the captured images over a number of frames; computing the threshold value based on the optimum value for a reference area of one or more frames. The resulting image is a binary image wherein each pixel is represented by one of two possible values: on or off (1 or 0). A distinct advantage of binary images is that they require much less data to represent an image than grayscale images. For example, a binary (i.e., 1-bit) image requires 1/8 the data of a corresponding 8-bit grayscale image. Because writing surfaces and instruments are designed to produce a high contrast, the exact value of the threshold is not too sensitive to variations in the actual physical environment, such as lighting and pen color. In a current implementation, the default threshold value is set to 5; if desired, the user can adjust this value, as necessary, through the user interface of the application program. For example, suppose the pixel depth is 8-bits and the data contains intensities that may range from −128 to +127. Accordingly, if the pixel value is between −128 and 4, the binary value is set to ‘off,’ otherwise the binary value is set to ‘on.’

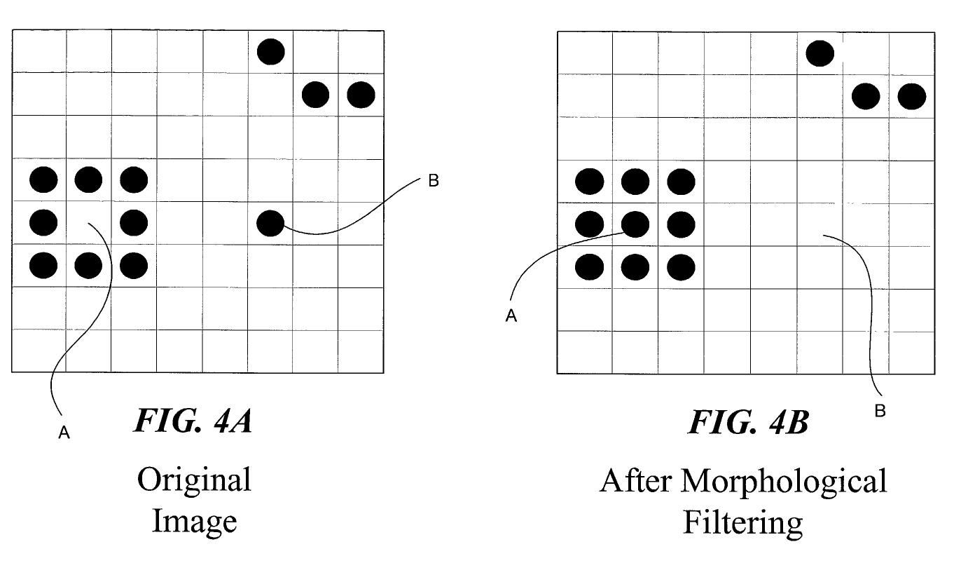

Morphological filtering may be applied in a block 214. This is a process that removes small groups of pixels not connected to other pixels, or fills small holes in an otherwise solid area. In a present implementation, a 3×3 morphology kernel is used to thin the grayscale image. As a result, any pixel that has all eight adjacent neighbors set to ‘off’ will also be turned to ‘off,’ while any pixel that has all eight adjacent neighbors set to ‘on’ will also be turned to ‘on.’ For example, as illustrated in FIGS. 4A and 4B, a missing pixel A in FIG. 4A is turned to ‘on’ in FIG. 4B, while an orphan pixel B in FIG. 4A is turned ‘off’ in FIG. 4B.

A blob analysis may be applied in a block 216. This is a process that groups pixels that are substantially adjacent to one another into blobs. Based on features that can be measured for each blob, the blobs are classified into (a) writings on the writing surface or (b) objects between the video capture device and the writing surface. Initially, blobs are identified by grouping substantially adjacent pixels with a color other than the background color into blobs. The blobs may then be classified as being part of a writing or not by examining features of the blob, wherein the determination is based on at least one of the following evaluations: a number of pixels in a blob; a width of a bounding box encompassing the blob; a height of a bounding box encompassing the blob; a ratio of a number of pixels in the blob versus the number of pixels in a bounding box encompassing the blob; and the color(s) of the pixels in the blob.

In the foregoing evaluation the idea is to eliminate blobs that do not possess the general properties of handwriting. In a present implementation, blobs that are too large in area for a reasonable stroke on the writing surface are considered to be objects in between the camera and the writing surface and can be optionally removed from the image under default parameters or user control. For example, the user is enabled to define a maximum line width, whereby objects that exceed the line width (i.e. objects comprising adjacent pixels that are more than the line width) are classified as blobs that are not part of the writing or line drawing. Accordingly, pixils comprising these blobs are removed from the remaining image data.

In a block 218, a color analysis may be performed This cooresponds to instances in which the writings/drawings are in multiple colors and it is desired to substantially preservie those colors in replicated images. Accordingly, each pixel is classified into one of a number of predefined colors based on the individual pixel's color attributes relative to the statistical color of the predefined colors in the frame and/or the color attributes of pixels proximate to that pixel. In one embodiment, the pixels are classified into five colors: white, black, red, green, and blue. White corresponds to the whiteboard, and black red, green and blue are the color of pens typically used to draw on whiteboards. Since white is the presumed background color in this instance, data only needs to be stored for the black, red, green, and blue pixels. Accordingly, if the colors of the pixels are assigned to values of N, where 1 represents white, and 2-5 represents black, red, green, and blue, the image data can be reduced such that each remaining (i.e., non-white) pixel has a value of 2<=N<=5. It will be recognized that the pixels may be classified into other numbers of values, depending on the number of different colors that are anticipated to being used. For example, if seven colors are to be used, then 2<=N<=8. Of note is the number N, which corresponds to the colors of pens typically used in writings and drawings, and is thus a small number, typically less than 5. This is a significant aspect of the present invention, which takes advantage of characteristics of writings and drawings. There are color compression schemes in the prior art, such as JPEG, which use various color mapping schemes to reduce the number of unique colors in an image. However, a number of colors as small as 5 does not provide a useful function for general images. Mapping an image to 5 unique colors is thus a novel technique first employed by the present invention in accordance with its goal of optimizing for writings and drawings.

In a block 220, image registration may be performed, if necessary. This function is executed if the writing surface or camera can shift during the duration of the session, or if the writing surface contains pre-printed material. In a present implementation, registration is performed by computing the normalized cross-correlation values for the parts of the surface that already has written or pre-printed material. The relative position of the present writing surface and the previous frame or the pre-printed material can be determined by searching for the location that yields the highest overall cross-correlation value.

In a block 222, a subtraction function is performed. After the images are cleared of noise and realigned, pixilated data corresponding to a previous frame are subtracted from pixelated data for the current frame, which typically will yield an almost empty frame of data, since most of the writings on the surface will remain the same as in the previous frame. Storing or transmitting the subtraction result therefore requires far less data than the original image. When subtracting image data is performed, the transmitted bitstream is encoded in a manner such that when the data is decoded at audience members' computers 128, only the additional data (i.e., pixels) are added to the previous frame. Preferably, the subtraction function should not be performed between every adjacent pair of frames, but rather performed on the majority of frames using an intermittent refresh. For instance, a full dataset (i.e., pixel data for an entire frame) may be provided every nth frame, thereby providing a data “refresh.” To further reduce data, frames which differ substantially over a wide area of the frame from the previous frame may be discarded. Since writings don't change quickly, frames with large changes are likely the result of undesired artifacts such as a moving person in front of the writings. Dropping such frames results in eliminating frames containing irrelevant data. As a safety measure, a watchdog timer of a few seconds will force acceptance of a full dataset frame after a string of discarded frames. Also, discarded data represent relatively static data, which are likely to be writings. Therefore, this data can optionally be saved and combined from frame to frame, resulting in a representation of the writings. This frame can be used as a full dataset frame.

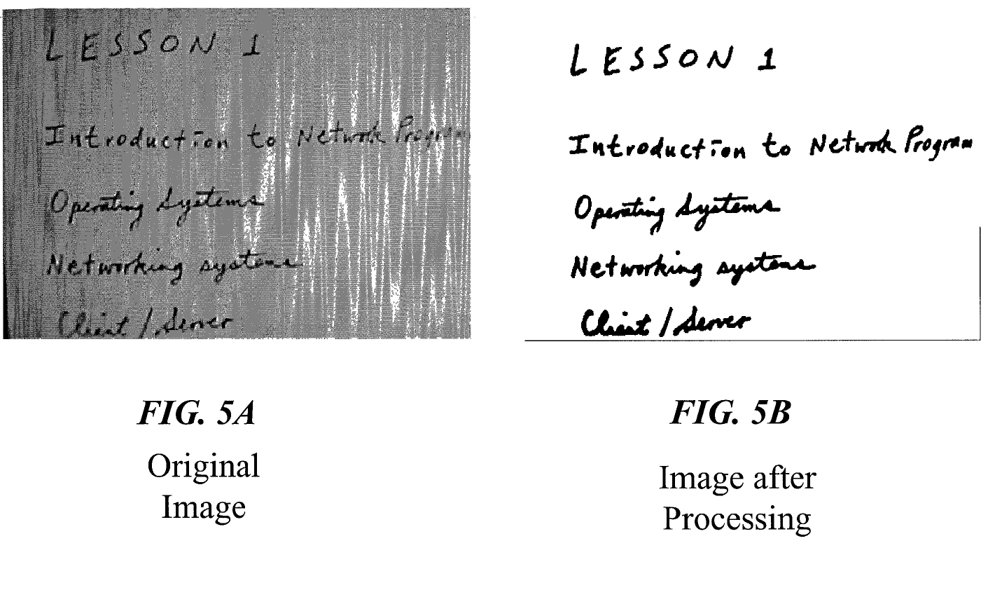

As a result of the foregoing image processing functions, a cleaned data block 224 corresponding to a “cleaned” image will be produced. In general, after processing each frame of data in this manner, the original numbers (i.e., the original pixilated data values) in the data buffer for that frame will have been substantially changed. These numbers now represent a graphical image with a clear background and crisp lines, as compared to the original image. A comparison of an actual image before and after image processing is shown in FIGS. 5A and 5B, respectively. The logic then loops back to block 204 to begin processing the next frame of image data. As will be understood by those skilled in the art, the processing of successive frames may be performed in parallel; that is the processing of a subsequent frame may begin prior to the completion of a previous frame.

Each cleaned data block 224 returned after the image processing functions is next passed to a data compression function 226, thereby producing a cleaned and compressed data block 228. In a current implementation, a run-length-encoding algorithm is used. It should be noted that there are many different compression algorithms that may be used, which will provide different compression ratios and/or loss characteristics that will depend on the nature of the data that is being compressed. Other types of compression encoding that may be used include Huffman encoding, LZ (Lempel and Ziv) and LZW (Lempel, Ziv, and Welch) encoding, and arithmetic compression, each of which are well-known in the art. Accordingly, further details of these compression schemes are not included herein. The optimum algorithm to use for the compression function is a flexibility supported by the present invention, and can vary or improve from time to time, without departing from the spirit of the invention taught herein.

As each cleaned and compressed data block 228 is produced, it is put into a data packet 230, and sent over network 118 to online audience members' computers 128, as provided by a block 232. Upon receiving each data packet 230, a decoding program or module running on online audience members' computers 128 decompresses and scales the data in a block 234 to produce a screen image 236. Optionally, the data packets may be streamed to a file for on-demand replay at a later point in time.

Composite Implementations

In addition to transmitting only data pertaining to writings and/or drawings, the present invention can be implemented to perform a composite implementation wherein the writings portion of the video images are cleaned using the foregoing image processing functions, while other portions of the video image are processed using conventional image compression and transfer techniques.

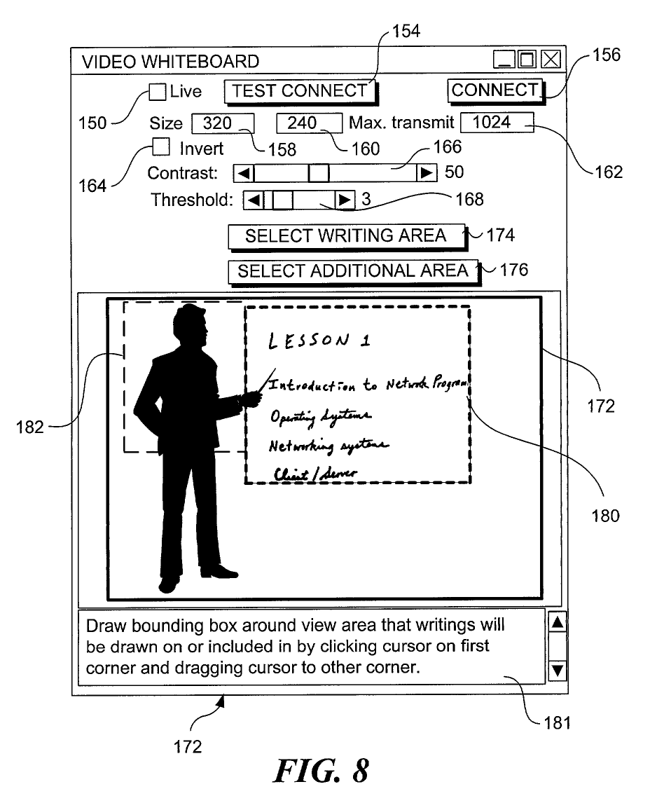

FIG. 8 shows a dialog 172 that enables a user to specify different types of image processing functions to be applied to selected portions of the field of view of video capture device 110. As shown, dialog 172 comprises UI components that are similar to dialog 150, with the addition of a “SELECT WRITING AREA” button 174 and a “SELECT ADDITIONAL AREA” button 176. In many instances, the field of view of video capture device 110 will not map directly to the area of the writing surface the presenter wishes to provide images for. For example, the width to height ratio of the video capture device may be different than the width-to-height ratio of the portion of the writing surface (e.g., entire whiteboard or chalkboard or portion thereof) written text and/or drawings will be entered on. Accordingly, the user may specify a portion of the field in for the writings by activating “SELECT WRITING AREA” button 174 and then drawing a rectangular bounding box corresponding to that portion within a field of view 178. For instance, suppose the user wants to only consider the outline of a whiteboard. The user would then identify the location of the whiteboard within field of view 178 on dialog 172 and draw a bounding box 180 around the whiteboard. In addition to the foregoing UI components, directions for guiding the use may be provided in a box 181.

By default, any area(s) of field of view 178 that are not selected for the writing area will be considered portions of the field of view that are not to be replicated during the online presentation. Accordingly, the pixilated data corresponding to these areas will not be processed beyond identification of their location, and the only data that will be transferred to the audience members' computers will correspond to the area selected for writing. However, in some instances, the user may wish to include other portions of the field of view of the video capture device, wherein pixilated data corresponding to the other portions are processed using conventional techniques. For example, if the user desires to include the presenter, the user would activate “SELECT ADDITIONAL AREA” button 176, and then draw a bounding box around the portion of the presenter and/or other participants the user desires to have replicated on the online audience members' computers, such as shown by a bounding box 182.

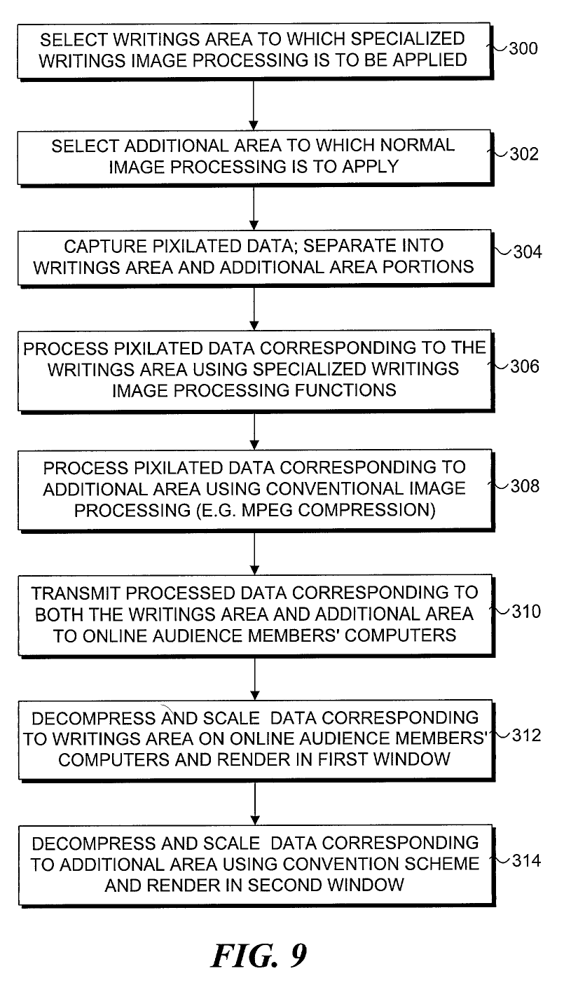

The logic performed during a composite implementation is shown in the flowchart of FIG. 9. In blocks 300 and 302 the user selects the writing area and the additional area, as described above. In a block 304, the pixilated data is captured from video capture device 110 and (if necessary) processed by video adapter 108, whereupon the data is separated into the portion of data corresponding to the writings are and the portion of data corresponding to the image processing area. In a block 306, the pixilated data corresponding to the writings area is processed using the specialized image processing functions described above with reference to FIG. 3. In a block 308 the pixilated data corresponding to the additional area is processed using conventional image processing techniques, such as the MPEG (Moving Picture Experts Group) standard. MPEG provides a method for compressing/decompressing video and audio in real time, and employs both frame-to-frame (temporal) compression and intra-frame compression. Depending on the built-in processing power of the implementation hardware, it may be necessary to use a special adapter board to perform MPEG processing. Such adapter boards are made by C-Cube, Optivision, and Sigma Designs. In addition, appropriate encoders and decoders will need to be implemented at both the presentation computer end and the receiving (i.e., audience member) computer end. MPEG is a widely recognized standard for video image processing, and accordingly, further details are not provided herein.

After the image processing for a given frame has been performed, encoded data corresponding to both the writings area and the additional area are transmitted to the online audience member's computers over an appropriate network, such as the Internet, as provided by a block 310. Upon receiving the data, the portions corresponding to the writings area and the additional area are decoded (decompressed and scaled) in blocks 312 and 314, respectively. In one embodiment, both portions of data are encoded into a single stream with special markers to delineate the two portions of data. Upon receiving this stream of data, software running on each audience member's computer separates that data into writings area and additional area portions based on the special markings and further software/hardware decoding is performed on the audience members' computers for each portion of the data so as to produce a composite replication of the visual content of the presentation as captured by video capture device 110. In another embodiment, each portion of encoded data is transmitted in a separate stream with timing marks such that both portions may be processed in a manner that synchronizes the video image when it is replicated.

Another variation on the composite implementation works in the following manner. During most of the presentation, the portion of the image corresponding to the writings area will be rendered in real-time. Generally, when the presenter is not writing or drawing, the presenter may actuate a control, such as a handheld button, that will switch the video image processing mode between the writings processing mode and the conventional mode. Upon switching to the conventional mode, the portion of the replicated display corresponding to the writing area will be “frozen.” Since the presenter is not writing anything new, there will be no need to update this portion of the replicated image. This will enable more resources to be devoted to real-time processing of the additional area.

The resulting composite image, when replicated by the online audience members' computers 128 will comprise a first window corresponding to replications of the writings area, and a second window corresponding to additional area, similar to that shown within bounding boxes 180 and 182, respectively. In general, the quality of the replication of the additional area will be dependent on the available bandwidth and the hardware used, especially for computer 102. As a result, it will generally be preferable that the additional area occupy less than half of the composite image. Accordingly, the two portions may be scaled differently such that the additional area occupies a smaller portion of the composite image than would be rendered based on the relative sizes of bounding boxes 180 and 182.

Demonstrated Results

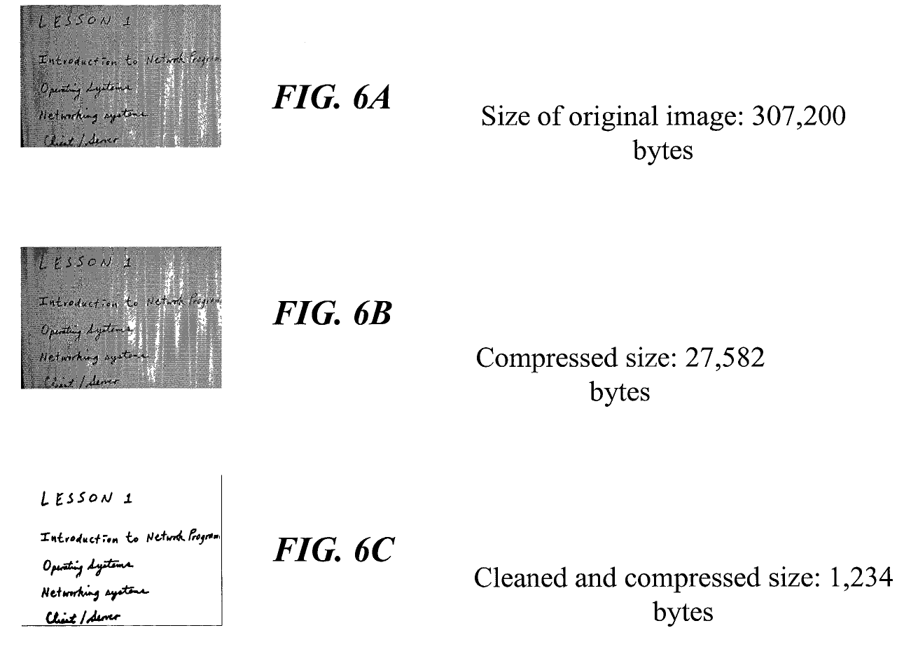

As illustrated in FIGS. 6A-6C, the present invention provides a substantial improvement over the prior art. In this exemplary case, an original image frame of data comprised 307,200 bytes after it was digitized by video adapter 114. Using a conventional image compression algorithm, as is done in the prior art, reduced the amount of data to 27,582 bytes. Under conventional schemes, this amount of data would then be sent to online audience members' computers 128, typically requiring multiple data packets that must be reassembled upon reaching their destination. In order to facilitate transferring data at this rate (consider that a frame rate of at least 10-30 frames/second is needed to produce an image with low jitter), a very-high bandwidth network connection must be available. This type of network connection is often unavailable, and is very costly. In contrast, the same image data after it is cleaned and compressed using the foregoing software implementation of the present invention comprises only 1,234 bytes. Furthermore, when the subtraction function is used, the average number of bytes per frame has been demonstrated to be only 100 bytes. This yields more than two orders of magnitude improvement over the prior art. Thus, a much lower bandwidth can be used to deliver the image content. In addition, the resulting image produced on the online audience member's computers is very crisp and clear, enabling the online audience members to easily follow the presenter as the presenter writes data on a whiteboard or chalkboard.

Although the present invention has been described in connection with a preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

What is claimed is:

1. A method for processing visual content corresponding to writings and/or line drawings presented during a presentation such that such visual content may be replicated for viewing by persons not attending the presentation, comprising:
directing a video capture device at a writing surface such that the writing surface occupies a substantial portion of a field of view of the video capture device;
capturing visual content with the video capture device pertaining to writings and/or line drawings created on the writing surface during the presentation or prepared on the writing surface in advance of the presentation, thereby producing a plurality of frames of pixilated data; and
cleaning up the visual content that is captured by processing the frames of pixilated data to remove data corresponding to artifacts in the visual content that do not pertain to the writings and/or line drawings through application of a set of image processing functions that remove such data based on unique characteristics of writings and/or line drawings that are used to distinguish pixilated data pertaining to the writings and/or line drawings from the pixilated data pertaining to the artifacts.

2. The method of claim 1, further comprising compressing the frames of pixilated data after the frames of pixilated data have been cleaned up.

3. The method of claim 2, further comprising:
transmitting the frames of the pixilated data that have been compressed over a network to an on-line audience member's computer;
decoding the frames of pixilated data at the on-line audience member's computer to produce a replication of the visual content of the presentation on the on-line audience member's computer.

4. The method of claim 3, further comprising:
capturing audio content produced during the presentation;
converting the audio content into compressed audio data;
transmitting the compressed audio data over the network to the on-line audience member's computer; and
decompressing the compressed audio data and applying further processing of the audio data on the on-line audience member's computer so as to replicate the audio content of the presentation at the on-line audience member's computer, in substantial synchrony with the visual content that is replicated.

5. The method of claim 2, further comprising storing the compressed frames of pixilated data into a file so as to enable on-demand viewing of the presentation at a later point in time.

6. The method of claim 1, wherein the video capture device produces data having color attributes, and wherein the set of processing functions includes converting the data with color attributes into grayscale data.

7. The method of claim 1, wherein the set of processing functions include performing a frame averaging function whereby the pixilated data values for a given frame are determined by averaging pixilated data values over a plurality of frames.

8. The method of claim 1, wherein the set of processing functions includes a flat field correction function that removes undesired artifacts including shadows, reflections, and lighting variations from the image data by performing a two-dimensional high-pass filter to remove low frequency pixel variations in the frames.

9. The method of claim 1, wherein the set of processing functions includes a thresholding function comprising converting the value of each pixel to either a binary one or zero based on whether an attribute of that pixel falls above or below a threshold value, said threshold value comprising a predetermined value based on one of characteristics corresponding to anticipated subject matter for the presentation, a user specified value, a calculated value based on a frame-by-frame analysis, or a calculated value based on analysis of data corresponding to various areas within the same frame.

10. The method of claim 1, wherein the set of processing functions includes performing a morphological filtering function comprising changing data values of individual pixels and/or small groups of pixels that have discontinuities with data values of adjacent pixels such that the discontinuities are removed.

11. The method of claim 1, wherein a color of the writing surface is defined as a background color, and wherein the set of processing functions includes grouping substantially adjacent pixels with a color other than the background color into blobs.

12. The method of claim 11, wherein the blobs are classified as (a) writings on the writing surface or (b) objects between the video capture device and the writing surface based on features of each blob, said features including at least one of:
a number of pixels in the blob;
a width of a bounding box encompassing the blob;
a height of a bounding box encompassing the blob;
a ratio of a number of pixels in the blob versus the number of pixels in a bounding box encompassing the blob; and
the color(s) of the pixels in the blob.

13. The method of claim 12, wherein the set of processing functions further includes discarding pixels belonging to blobs that are classified as objects between the video capture device and the writing surface.

14. The method of claim 1, wherein the set of processing functions includes classifying each pixel into one of N color categories, where 2<=N<=M band M<=8, based on the color of that pixel and/or the color of the pixels in the vicinity of that pixel.

15. The method of claim 14, wherein 2<=N<=5 corresponding to pixels that are not the color of the writing surface being categorized as being black, red, green and blue.

16. The method of claim 1, wherein the set of processing functions includes performing an image registration function enabling data corresponding to frames that are captured while the video capture device may have been shifted relative to the writing surface to be aligned with frames captured prior to the video capture device being shifted relative to the writing surface.

17. The method of claim 1, wherein the set of processing functions includes: performing a subtraction function, whereby data values for pixels corresponding to a previous frame are subtracted from data values for those pixels in a current frame; and
discarding data corresponding to pixel values that have not changed between the previous frame and the current frame.

18. The method of claim 17, further comprising:
determining if a frame comprises irrelevant data based on whether the data values after subtraction for selected pixels or for a number of pixels spread out over a substantial area of the frame exceed a threshold indicating that there is a substantial difference between the data values in the previous and current frames; and
discarding those frames that are determined to comprise irrelevant data.

19. The method of claim 18, wherein a count is maintained comprising a number of sequential frames that have been discarded, further comprising forcing a discarded frame to be retrained if the count reaches a threshold value.

20. The method of claim 17, wherein after subtraction function is performed, discarded data corresponding to pixel values that have not changed between the previous frame and the current frame are saved into a reference frame by combining the discarded data with data saved from previous frames.

21. The method of claim 20, wherein the saved data are merged with previously saved data by adding the data and then averaging the resultant sum over the number of frames for which data is contributed.

22. The method of claim 20, wherein a thresholding function is applied to the data saved in the previous frames in order to remove data that exist in less than a desired number of frames.

23. The method of claim 20, wherein the reference frame can be retrieved on demand and transmitted or otherwise saved into a permanent medium.

24. The method of claim 1, further comprising:
enabling a user to select an area within the field of view of the video capture device in which the drawings and/or line drawings of the presentation are to be located;
identifying pixilated data corresponding to the area selected by the user and portions of the field of view outside of the area selected by the user; and
performing image processing on the pixelated data to clean up the visual content only on pixelated data corresponding to the area selected by the user.

25. A method for processing visual content corresponding to writings and/or line drawings presented during a presentation such that such visual content may be replicated for viewing by persons not attending the presentation, comprising:
directing a video capture device at a writing surface such that the writing surface occupies a substantial portion of a field of view of the video capture device;
capturing visual content with the video capture device pertaining to writings and/or line drawings created on the writing surface during the presentation or prepared on the writing surface in advance of the presentation, thereby producing a plurality of frames of pixilated data;
performing a flat field correction function that removes undesired artifacts including shadows, reflections, and lighting variations from the image data by performing a two-dimensional high-pass filter to remove low frequency pixel variations in the frames;
performing a blob analysis function comprising:
grouping substantially adjacent pixels with a color other than a background color of the writing surface into blobs; and
classifying the blobs into (a) writing or drawing marks on the writing surface or (b) objects between the video capture device and the writing surface based on features of each blob; and
removing pixelated data corresponding blobs that are classified as objects between the video capture device and the writing surface; and
performing a frame averaging function whereby the pixilated data values for a given frame are determined by averaging pixilated data values over a plurality of frames.

26. The method of claim 25, further comprising performing a thresholding function comprising converting the value of each pixel to either a binary one or zero based on whether an attribute of that pixel falls above or below a threshold value, said threshold value comprising a predetermined value based on one of characteristics corresponding to anticipated subject matter for the presentation, a user specified value, a calculated value based on a frame-by-frame analysis, or a calculated value based on analysis of data corresponding to various areas within the same frame.

27. The method of claim 25, further comprising:
performing a subtraction function, whereby data values for pixels corresponding to a previous frame are subtracted from data values for those pixels in a current frame; and
discarding data corresponding to pixel values that have not changed between the previous frame and the current frame.

28. A method for processing visual content corresponding to writings and/or line drawings presented during a presentation such that such visual content may be replicated over the Internet to an online audience, comprising:
directing a video capture device at a writing surface such that the writing surface occupies a substantial portion of a field of view of the video capture device;
capturing visual content with the video capture device pertaining to writings and/or line drawings created on the writing surface during the presentation or prepared on the writing surface in advance of the presentation, thereby producing a plurality of frames of pixilated data;
cleaning up the visual content that is captured by processing the frames of pixilated data to remove data corresponding to artifacts in the visual content that do not pertain to the writings and/or line drawings through application of a set of image processing functions that remove such data based on unique characteristics of writings and/or line drawings that are used to distinguish pixilated data pertaining to the writings and/or line drawings from the pixilated data pertaining to the artifacts;
compressing the frames of pixilated data after the frames of pixilated data have been cleaned up to produce encoded data;
transmitting the encoded data over the Internet to an on-line audience member's computer;
decoding the encoded data at the on-line audience member's to produce a replication of the visual content of the presentation on the on-line audience member's computer.

29. The method of claim 28, further comprising:
capturing audio content produced during the presentation;
converting the audio content into compressed audio data;
transmitting the compressed audio data over the Internet to the on-line audience member's computer; and
decoding the compressed audio data on the on-line audience member's computer so as to replicate the audio content of the presentation at the on-line audience member's computer, in substantial synchrony with the visual content that is replicated.

30. A method for processing visual content including a first portion corresponding to writings and/or line drawings presented during a presentation and a second portion corresponding to additional visual content corresponding to the presentation such that the visual content is replicated on an online audience member's computer, comprising:
directing a video capture device at a writing surface such that the writing surface occupies a portion of a field of view of the video capture device;
enabling a user to define a first portion of the field of view of the video capture device corresponding to a writings area in which the writings and/or line drawings will be displayed during the presentation;
enabling the user to define a second portion of the field of view of the video capture device corresponding to an additional area of the visual content that is to be replicated for viewing by persons not attending the presentation
capturing visual content with the video capture device to produce a plurality of frames of pixilated data;
separating portions of the pixilated data into data corresponding to the writings area and the additional area;
cleaning up the pixilated data corresponding to the writings area to produce a first portion of encoded data by removing data corresponding to artifacts in the visual content that do not pertain to the writings and/or line drawings through application of a set of image processing functions that remove such data based on unique characteristics of writings and/or line drawings that are used to distinguish pixilated data pertaining to the writings and/or line drawings from the pixilated data pertaining to the artifacts;
applying conventional image processing techniques to the pixilated data corresponding to the additional area to produce a second portion of encoded data, wherein the conventional image processing technique reduces an amount of data that describes each frame;
transmitting the first and second portions of encoded data over a communications network to an on-line audience member's computer; and
decoding the first and second portions of encoded data on the online audience member's computer to produce a composite image that comprises a replication of both the writings area portion and the additional area portion of the visual content of the presentation.

31. The method of claim 30, wherein the conventional image processing technique comprises MPEG compression.

32. The method of claim 30, wherein the first and second portions of the encoded data are transmitted in a single stream of data.

33. The method of claim 30, wherein the first and second portions of the encoded data are transmitted in separate streams of data.

34. An article of manufacture comprising a medium on which a plurality of machine-readable instructions are stored, said machine-readable instructions when executed performing functions including:
capturing visual content with a video capture device that is directed at a writing surface such that the writing surface occupies a substantial portion of a field of view of the video capture device, said visual content pertaining to writings and/or line drawings created on the writing surface during the presentation or prepared on the writing surface in advance of the presentation, thereby producing a plurality of frames of pixilated data; and
cleaning up the visual content that is captured by processing the frames of pixilated data to remove data corresponding to artifacts in the visual content that do not pertain to the writings and/or line drawings through application a set of processing functions that remove such data based on unique characteristics of writings and/or line drawings that are used to distinguish pixilated data pertaining to the writings and/or line drawings from the pixilated data pertaining to the artifacts.

35. The article of manufacture of claim 34, wherein execution of the machine-readable instructions cleans up the visual content by performing the functions of:
performing a flat field correction function that removes undesired artifacts including shadows, reflections, and lighting variations from the image data by performing a two-dimensional high-pass filter to remove low frequency pixel variations in the frames;
performing a blob analysis function comprising:
grouping substantially adjacent pixels with a color other than a background color of the writing surface into blobs; and
classifying the blobs into (a) writing or drawing marks on the writing surface or (b) objects between the video capture device and the writing surface based on features of each blob; and
removing pixelated data corresponding blobs that are classified as objects between the video capture device and the writing surface; and
performing a frame averaging function whereby the pixilated data values for a given frame are determined by averaging pixilated data values over a plurality of frames.

36. A system for capturing visual content corresponding to writings and/or line drawings presented during a presentation such that such visual content may be replicated for viewing by persons not attending the presentation, comprising:
a first computer including:
a memory in which a plurality of machine instructions are stored;
a processor, coupled to the memory; and
a display screen; and
a video capture device, linked in communication with the computer;
wherein execution of the machine instructions on said processor causes the first computer to perform the functions of:
capturing visual content with a video capture device that is directed at a writing surface such that the writing surface occupies a substantial portion of a field of view of the video capture device, said visual content pertaining to writings and/or line drawings created on the writing surface during the presentation or prepared on the writing surface in advance of the presentation, thereby producing a plurality of frames of pixilated data; and
cleaning up the visual content that is captured by processing the frames of pixilated data to remove data corresponding to artifacts in the visual content that do not pertain to the writings and/or line drawings through application a set of processing functions that remove such data based on unique characteristics of writings and/or line drawings that are used to distinguish pixilated data pertaining to the writings and/or line drawings from the pixilated data pertaining to the artifacts.

37. The system of claim 36, further comprising a video adapter coupled to the computer, said video adapter processing analog input from the video capture device to produce the plurality of frames of pixilated data.

38. The system of claim 36, further comprising:
a microphone; and
an audio adapter coupled to the computer and receiving audio input signals from the microphone, said audio adapter converting the audio input signals into a digital format.

39. The system of claim 36, further comprising:
a second computer linked to the first computer via a network connection, said second computer including:
a memory in which a plurality of machine instructions are stored;
a processor, coupled to the memory; and
a display screen,
wherein execution of the machine instructions by the processor in the first computer cause the first computer to further perform the functions of:
compressing the frames of pixilated data after the frames of pixilated data have been cleaned up to produce encoded data;
transmitting the encoded data over the network connection to the second computer,
and wherein execution of the machine instructions by the processor in the second computer causes the second computer to decode the encoded data were transmitted to the second computer to produce a replication of the visual content of the presentation on the display screen of the second computer.
